(19) United States
(12) Patent Application Publication
(10) Pub. No.: US 2023/0365773 A1
(43) Pub. Date: Nov. 16, 2023

(54) High Melt Strength Polystyrene Compositions and Methods of Making and Using Same

(71) Applicant: FINA TECHNOLOGY, INC., Houston, TX (US)

(72) Inventors: Jayna Brown, Houston, TX (US); Fengkui LI, Houston, TX (US); Wyman Stephens, Baytown, TX (US)

(21) Appl. No.: 17/743,957

(22) Filed: May 13, 2022

(51) Int. Cl. C08J 9/14; C08K 3/34

(52) U.S. Cl. CPC C08J 9/141; C08K 3/346; C08J 2203/14; C08J 2325/08

(57) ABSTRACT

A method of making foamed styrenic copolymer comprising reacting the styrenic copolymer with an ionomer to form a composition; and contacting a blowing agent with the composition to form the foamed styrenic polymer. An article formed from a composition comprising a styrenic copolymer, an ionomer and a blowing agent.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

### Technical Field

This disclosure relates generally to polystyrene compositions. More specifically, this disclosure relates to foamed polystyrene compositions having lower foam densities and improved surface quality.

### Background of the Technology

Polystyrene compositions, for example foamed polystyrene compositions, are useful in a variety of applications. Foamed polystyrene offers the advantages of low cost and excellent physical properties such as high structural strength and low density. Extruded polystyrene (XPS) foams produced with hydrocarbon blowing agents are commonly used to manufacture a wide array of items such as disposable foam packaging (meat trays, clam shells, etc.).

### BRIEF SUMMARY

Disclosed herein is a method of making foamed styrenic copolymer comprising reacting the styrenic copolymer with an ionomer to form a composition; and contacting a blowing agent with the composition to form the foamed styrenic polymer.

Also disclosed herein is an article formed from a composition comprising a styrenic copolymer, an ionomer and a blowing agent.

Also disclosed herein is a foamed polystyrene comprising (i) a styrenic copolymer (ii) an ionomer; and (iii) a blowing agent wherein the ionomer is present in an amount of from about 500 ppm to about 2500 ppm; wherein the blowing agent is present in an amount of from about 1% to about 10% and wherein the foamed polystyrene has a density of from about 0.040 g/cc to about 0.100 g/cc.

### BRIEF DESCRIPTION OF THE DRAWINGS

FIG. 1 is a graph illustrating the melt strength of the samples from Example 1.

FIG. 2 is a graph illustrating the density as a function of the blowing agent concentration for the samples from Example 2.

FIG. 3 is a photograph of the surface defects formed in the samples from Example 3.

### DETAILED DESCRIPTION

As noted above, XPS foams are used to manufacture a wide array of products. Many manufacturers seek to reduce the density of their final products (light weight) to lower the cost of resin, shipping, or taxes. XPS manufactured goods are often produced in a thermoforming process using rolls of polystyrene sheet or directly extruded into boards that are prone to surface corrugation. Foam corrugation creates surface defects that can increase recycle, waste, customer complaints, and costs for manufacturers. Accordingly, there is a need for foamed polystyrene compositions able to provide lower density final articles with a reduced occurrence of surface defects.

Disclosed herein are foamed polystyrene compositions having improved melt strength and methods of making and using same. In an aspect, the polymeric composition comprises a styrenic copolymer and an ionomer. Such compositions may produce a foamed polystyrene displaying an increased melt strength and characterized by the formation of lower density polystyrenic foams. These compositions having been prepared as described herein, will be referred to as polystyrene compositions having improved melt strength (PSIMS).

In an aspect, the PSIMS comprises a styrene, wherein the styrene may be a homopolymer or may optionally comprise one or more comonomers. Styrene, also known as vinyl benzene, ethyenylbenzene and phenylethene is an organic compound represented by the chemical formula C₈H₈. Styrene is widely commercially available and as used herein the term styrene includes a variety of substituted styrenes (e.g., alpha-methyl styrene), ring-substituted styrenes such as p-methylstyrene, disubstituted styrenes such as p-t-butyl styrene as well as unsubstituted styrenes.

In an aspect, styrene is present in the PSIMS an amount of from about 95 wt. % to about 99.99 wt. % weight percent (wt. %), alternatively from about 96 wt. % to about 99.99 wt. % or alternatively from alternatively from about 97 wt. % to about 99.99 wt. %. Herein the weight percent is based on the total weight of the composition. In an aspect, styrene comprises the balance of the PSIMS when other ingredients are accounted for.

In some aspects, the styrenic polymer further comprises a comonomer, which when polymerized with the styrene forms a styrenic copolymer. Examples of such comonomers may include for example and without limitation α-methylstyrene; halogenated styrenes; alkylated styrenes; acrylonitrile; esters of (meth)acrylic acid with alcohols having from 1 to 8 carbons; N-vinyl compounds such as vinylcarbazole, maleic anhydride; compounds that contain two polymerizable double bonds such as for example and without limitation divinylbenzene or butanediol diacrylate; or combinations thereof. The comonomer may be present in an amount effective to impart one or more user-desired properties to the composition. Such effective amounts may be determined by one of ordinary skill in the art. For example, the comonomer may be present in the styrenic copolymer in an amount ranging from about 0.05 wt. % to about 5 wt. %, alternatively from about 0.5 wt. % to about 5 wt. %, or alternatively from about 1 wt. % to about 5 wt. %.

In some aspects, the styrenic copolymer further comprises an elastomer, and the resultant composition may be a high impact composition (HIC). Such HICs contain an elastomeric phase that is embedded in the polystyrene matrix resulting in the composition having an increased impact resistance. In an aspect, the styrenic copolymer composition is a HIC comprising a conjugated diene monomer as the elastomer. Nonlimiting examples of conjugated diene monomers suitable for use in the present disclosure include without limitation 1,3-butadiene, 2-methyl-1,3-butadiene, 2 chloro-1,3 butadiene, 2-methyl-1,3-butadiene, and 2 chloro-1,3-butadiene. Alternatively, the HIC comprises an aliphatic conjugated diene monomer as the elastomer. Without limitation, examples of aliphatic conjugated diene monomers suitable for use in the present disclosure include C₄ to C₉ dienes such as butadiene monomers. Blends or copolymers of the diene monomers may also be used. The elastomer may be present in amounts effective to produce one or more user-desired properties. Such effective amounts may be determined by one of ordinary skill in the art.

In an aspect, the PSIMS comprises an ionomer which functions to facilitate the incorporation of a blowing agent into the composition. In an aspect, the ionomer is a metallic acrylate salt. Nonlimiting examples of ionomers suitable for use in the present disclosure include zinc dimethacrylate, stearyl methacrylate, hydroxyethylmethacrylate or a combination thereof. In an aspect, the ionomer comprises zinc dimethacrylate. The ionomer may be present in the PSIMS in an amount of from about 500 ppm to about 2500 ppm, alternatively from about 500 ppm to about 2000 ppm or alternatively from about 1000 ppm to about 2000 ppm.

In an aspect, a process for the production of the PSMIS comprises contacting the styrenic monomer, an optional comonomer, and an ionomer with at least one initiator. Any initiator capable of free radical formation that facilitates the polymerization of styrene may be employed. Such initiators are well known in the art and include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides, or combinations thereof. The selection of initiator and effective amount will depend on numerous factors (e.g. temperature, reaction time) and can be chosen by one skilled in the art to meet the desired needs of the process. Polymerization initiators and their effective amounts have been described in U.S. Pat. Nos. 6,822,046; 4,861,127; 5,559,162; 4,433,099 and 7,179,873, each of which is hereby incorporated herein by reference herein in its entirety for all purposes.

In an aspect, the polymerization reaction to form the PSMIS may be carried out in a solution or mass polymerization process. Mass polymerization, also known as bulk polymerization refers to the polymerization of a monomer in the absence of any medium other than the monomer and a catalyst or polymerization initiator. Solution polymerization refers to a polymerization process in which the monomers and polymerization initiators are dissolved in a non-monomeric liquid solvent at the beginning of the polymerization reaction. The liquid is usually also a solvent for the resulting polymer or copolymer.

The polymerization process can be either batch or continuous. In an aspect, the polymerization reaction may be carried out using a continuous production process in a polymerization apparatus comprising a single reactor or a plurality of reactors. For example, the polymeric composition can be prepared using an upflow reactor. Reactors and conditions for the production of a polymeric composition are disclosed in U.S. Pat. No. 4,777,210, which is hereby incorporated herein by reference herein in its entirety for all purposes.

The temperature ranges useful with production of the PSIMS can be selected to be consistent with the operational characteristics of the equipment used to perform the polymerization. In one aspect, the temperature range for the polymerization can be from 90° C. to 240° C. In another aspect, the temperature range for the polymerization can be from 100° C. to 180° C. In yet another aspect, the polymerization reaction may be carried out in a plurality of reactors with each reactor having an optimum temperature range. For example, the polymerization reaction may be carried out in a reactor system employing a first and second polymerization reactors that are either continuously stirred tank reactors (CSTR) or plug-flow reactors. In an aspect, a polymerization reactor for the production of a PSIMS comprises a plurality of reactors may have the first reactor (e.g. a CSTR), also known as the prepolymerization reactor, operated in the temperature range of from 90° C. to 135° C. while the second reactor (e.g. CSTR or plug flow) may be operated in the range of from 100° C. to 165° C.

The polymerized product effluent from the first reactor may be referred to herein as the prepolymer. When the prepolymer reaches the desired conversion, it may be passed through a heating device into a second reactor for further polymerization. The polymerized product effluent from the second reactor may be further processed as is known to one of ordinary skill in the art and described in detail in the literature. Upon completion of the polymerization reaction, a PSIMS is recovered and subsequently processed, for example devolatized, pelletized, etc.

In an aspect, the PSIMS may also comprise additives as deemed necessary to impart desired physical properties, such as, increased gloss or color. Examples of additives include without limitation chain transfer agents, talc, antioxidants, UV stabilizers, lubricants, mineral oil, plasticizers, and the like. The aforementioned additives may be used either singularly or in combination to form various formulations of the composition. For example, stabilizers or stabilization agents may be employed to help protect the polymeric composition from degradation due to exposure to excessive temperatures and/or ultraviolet light. These additives may be included in amounts effective to impart the desired properties. Effective additive amounts and processes for inclusion of these additives to polymeric compositions are known to one skilled in the art. For example, one or more additives may be added after recovery of the PSIMS, for example during compounding such as pelletization. Alternatively, such additives may be added during formation of the PSIMS or to one or more other components of the PSMIS.

In an aspect, the PSIMS comprises a blowing agent. Herein, a blowing agent refers to a substance that is capable of producing a cellular structure via a foaming process in a variety of materials that undergo hardening or phase transition, such as polymers, plastics, and metals. In an aspect, a blowing agent suitable for use in the present disclosure comprises nitrogen, carbon dioxide, water, air, pentane, hexane, dichloroethane, isobutane, or a combination thereof. The blowing agent may be contacted with the PSIMS in an amount ranging from about 1% to about 10%, alternatively from about 2% to about 6% or alternatively from about 3% to about 4%.

In an aspect, the PSIMS is contacted with the blowing agent, and thoroughly mixing the components for example by compounding or extrusion. In an aspect, the styrenic copolymer is plasticized or melted by heating in an extruder and is contacted and mixed thoroughly with the blowing agent (e.g., isobutane) at a temperature ranging from about 315° F. to about 460° F., alternatively from about 155° F. to 460° F. or alternatively from about 155° F. to about 240° F.

Alternatively, the styrenic copolymer may be contacted with the blowing agent prior to introduction of the mixture to the extruder (e.g., via bulk mixing), during the introduction of the styrenic copolymer to an extruder, or combinations thereof.

In an aspect, the foamed PSIMS composition may then pass through a relaxation zone, in the last stage of extruder prior to being introduced to the die, in which it is cooled. The PSIMS may be cooled from a temperature ranging from 150° C. to 210° C. to a temperature ranging from 40° C. to 100° C. with continuous stirring before being extruded through a die. Methods for preparing a foamed polystyrene composition are described in U.S. Pat. Nos. 5,006,566 and 6,387,968, each of which is hereby incorporated herein by reference herein in its entirety for all purposes.

Without wishing to be limited by theory, the presence of an ionomer (e.g., ZDMA) in the polystyrene chains of the PSIMS improves the strength of the polymer melt which forms the cell wall of foams. Therefore, more blowing agent is retained in the melt during blowing agent expansion resulting in a reduction of cell collapse.

In an aspect, the PSIMS may be characterized by an increased melt strength. For example, a PSIMS may display a melt strength in the range of from about 0.035 N to about 0.048 N, alternatively from about 0.038 N to about 0.045 N, or alternatively from about 0.039 N to about 0.041 N.

In an aspect, the PSIMS may be characterized by a melt flow rate comparable to an otherwise similar styrenic copolymer composition lacking an ionomer in the amounts disclosed herein. For example, the PSIMS may have a melt flow rate ranging from about 1.0 g/10 min to about 5.0 g/10 min, alternatively from about 1.2 g/10 min to about 3.0 g/10 min or, alternatively from about 1.5 g/10 min to about 1.8 g/10 min as determined in accordance with ASTM D-1238.

In an aspect, the PSIMS may be characterized by a reduced density. For example, the PSIMS may have a density of from about 0.040 g/cc to about 0.100 g/cc, alternatively from about 0.045 g/cc to about 0.090 g/cc or alternatively from about 0.050 g/cc to about 0.080 g/cc.

The PSIMS of this disclosure may be converted to articles by any suitable method. The articles may be produced about concurrently with the mixing and/or foaming of the PSIMS (e.g., on a sequential, integrated process line) or may be produced subsequent to mixing and/or foaming of the PSIMS (e.g., on a separate process line such as an end use compounding and/or thermoforming line). In an aspect, the PSIMS is mixed and foamed via extrusion or compounding as described herein, and the molten PSIMS is fed to a shaping process (e.g., mold, die, lay down bar, etc.) where the PSIMS is shaped. The foaming of the PSIMS may occur prior to, during, or subsequent to the shaping.

In an aspect, molten PSIMS is injected into a mold, where the PSIMS undergoes foaming and fills the mold to form a shaped article. In an aspect, the PSIMS is formed into a sheet, which is then subjected to further processing steps such as thermoforming to produce an article. Examples of articles into which the PSIMS may be formed include food packaging; office supplies; plastic lumber or replacement lumber; patio decking; structural supports; laminate flooring compositions; polymeric foam substrate and decorative surfaces such as crown molding; weatherable outdoor materials; point-of-purchase signs and displays; housewares and consumer goods; building insulation; cosmetics packaging; outdoor replacement materials; and so forth. Additional articles would be apparent to those skilled in the art.

The PSIMS of the present disclosure advantageously provide for the increased incorporation of blowing agent into a styrenic copolymer that results in a reduced density foamed polymer. For example, a PSMIS of the present disclosure is a foamed polystyrene comprising (i) a styrenic copolymer, (ii) an ionomer; and (iii) a blowing agent wherein the ionomer is present in an amount of from about 500 ppm to about 2500 ppm; wherein the blowing agent is present in an amount of from about 1% to about 10% and wherein the foamed polystyrene has a density of from about 0.040 g/cc to about 0.100 g/cc. In an alternative aspect, the ionomer is present in an amount of from about 500 ppm to about 2500 ppm; wherein the blowing agent is present in an amount of from about 5% to about 6% and the foamed polystyrene has a density of less than about 0.100 g/cc.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner.

### Example 1

The melt flow rate of a PSIMS of the type disclosed herein was investigated. Specifically, a polystyrene containing zinc dimethacrylate, designated sample 595T, displayed a melt flow rate comparable to a control polystyrene composition, designated sample 585. Both samples were found to have a melt flow rate of 1.6 g/10-min as determined in accordance with ASTM D-1238.

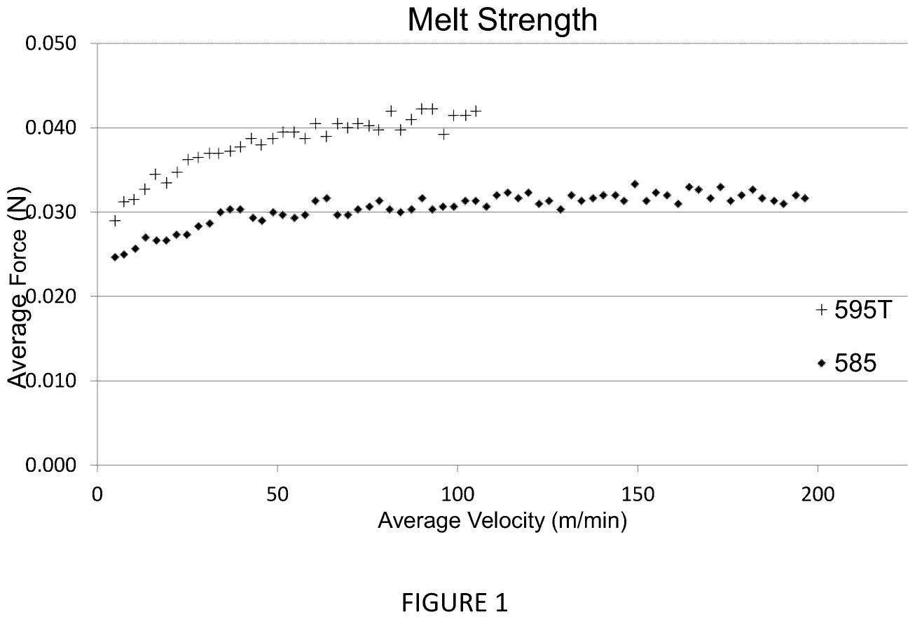

The melt strength of sample 595T was compared that of a control polystyrene composition, designated sample 585. Both samples were foamed using isobutane as the blowing agent and 0.5 wt % talc as the nucleator. The secondary extruder temperatures were adjusted to maintain a die head pressure between 1100 psi and 1200 psi. The 5 mm rod die was used. A gear pump was used to maintain a throughput of approximately 6.5 lbs/hr. FIG. 1 display results of the melt strength analysis.

### Example 2

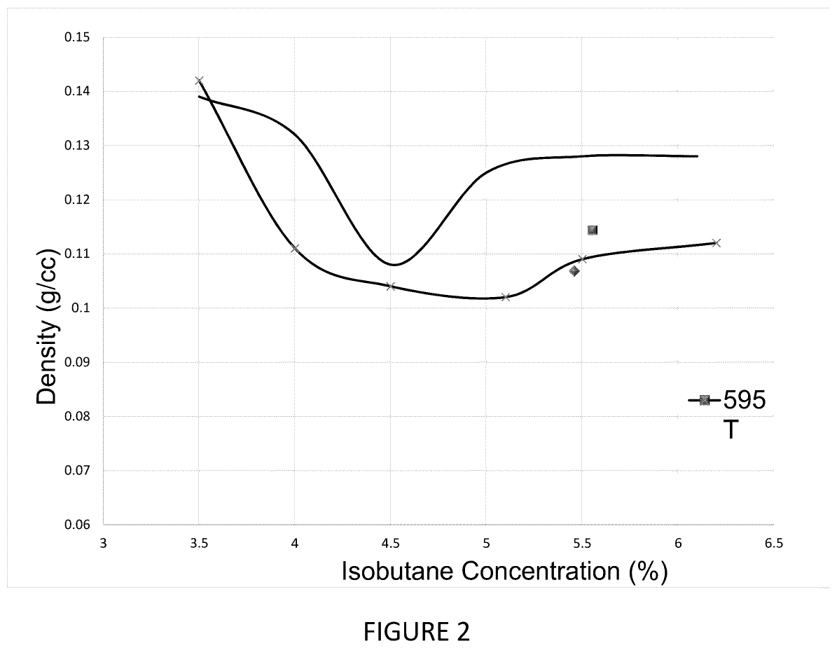

The ability to form lower density polystyrenic compositions utilizing PSIMS of the present disclosure were investigated. Specifically, foamed samples of the 595T composition were prepared using between 4% and 6.2% isobutane blowing agent and compared to a 585 composition also containing between 4% and 6.2% isobutane blowing agent. The results are presented in FIG. 2. The 595T sample displayed lower densities at higher concentrations of isobutane (4-6.2%). The PSIMS, sample 595T, exhibited foam densities that were approximately 11% lower than the 585 control sample foam densities when the amount of blowing agent, isobutane, ranged from 3.5% to 6.2% isobutane.

### Example 3

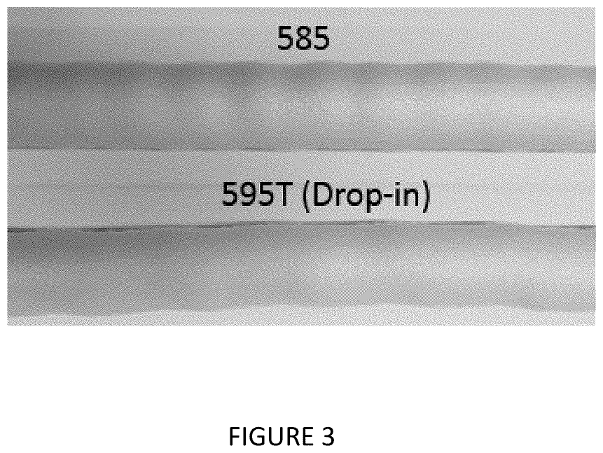

The ability of polystyrenic compositions utilizing PSIMS of the present disclosure to form articles having less surface defects was investigated. The effect on surface corrugation was evaluated by adding the 595T sample to a lab-scale foam line behind the 585 sample while maintaining the same processing conditions and a blowing agent concentration of 5% isobutane. Once the processing conditions stabilized and a 595T foam was being produced, a sample was collected. The 595T-sample showed improvements in surface corrugation as compared to the 585-control sample. Overall, the 595T sample exhibited a much smoother surface containing fewer surface ridges. The foams are shown in FIG. 3.

### ADDITIONAL DISCLOSURE

The following enumerated aspects of the present disclosures are provided as nonlimiting examples.

A first aspect which is a method of making foamed styrenic copolymer comprising reacting the styrenic copolymer with an ionomer to form a composition; and contacting a blowing agent with the composition to form the foamed styrenic polymer.

A second aspect which is the method of the first aspect wherein the reacting occurs during extrusion.

A third aspect which is the method of any of the first through second aspects wherein the styrenic copolymer comprises styrene, ring-substituted styrene, disubstituted styrene, unsubstituted styrene, or a combination thereof.

A fourth aspect which is the method of any of the first through third aspects wherein the styrenic copolymer comprises alpha-methyl styrene, p-methylstyrene, p-t-butyl styrene, or a combination thereof.

A fifth aspect which is the method of any of the first through fourth aspects wherein the styrenic copolymer further comprises a comonomer.

A sixth aspect which is the method of the fifth aspect wherein the comonomer comprises α-methylstyrene; halogenated styrenes; alkylated styrenes; acrylonitrile; esters of (meth)acrylic acid with alcohols having from 1 to 8 carbons; vinylcarbazole, maleic anhydride; divinylbenzene; butanediol diacrylate; or a combination thereof

A seventh aspect which is the method of any of the first through sixth aspects wherein the styrenic copolymer further comprises an elastomer.

An eighth aspect which is the method of the seventh aspect wherein the elastomer comprises a diene monomer, an aliphatic conjugated diene monomer, or a combination thereof.

A ninth aspect which is the method of the seventh aspect wherein the elastomer comprises 1,3-butadiene, 2-methyl-1,3-butadiene, 2 chloro-1,3 butadiene, 2-methyl-1,3-butadiene, 2-chloro-1,3-butadiene, or a combination thereof.

A tenth aspect which is the method of the seventh aspect wherein the styrenic copolymer is a high impact polystyrene.

An eleventh aspect which is the method of any of the first through tenth aspects wherein the styrenic copolymer is present an amount of from about 95 wt. % to about 99 wt. % based on the total weight of the composition.

A twelfth aspect which is the method of any of the first through eleventh aspects wherein the ionomer comprises a metallic acrylate salt.

A thirteenth aspect which is the method of the twelfth aspect wherein the metallic acrylate salt comprises zinc dimethacrylate, stearyl methacrylate, hydroxyethylmethacrylate, or a combination thereof.

A fourteenth aspect which is the method of any of the first through thirteenth aspects wherein the ionomer comprises zinc dimethacrylate.

A fifteenth aspect which is the method of any of the first through fourteenth aspects wherein the ionomer is present in an amount of from about 500 ppm to about 2500 ppm based on the total weight of the composition.

A sixteenth aspect which is the method of any of the first through fifteenth aspects wherein the composition has a melt strength ranging from about 0.035 N to about 0.048 N.

A seventeenth aspect which is the method of any of the first through sixteenth aspects wherein the composition has a melt flow rate of from about 1 g/10 min to about 5 g/10 min.

An eighteenth aspect which is the method of any of the first through seventeenth aspects wherein the composition has a density of from about 0.04 g/cc to about 0.08 g/cc.

A nineteenth aspect which is the method of any of the first through eighteenth aspects wherein the blowing agent comprises nitrogen, carbon dioxide, water, air, pentane, hexane, dichloroethane, isobutane, or a combination thereof.

A twentieth aspect which is an article formed from a composition comprising a styrenic copolymer, an ionomer and a blowing agent.

While various aspects have been shown and described, modifications thereof can be made by one skilled in the art without departing from the spirit and teachings of the disclosure. The aspects described herein are exemplary only, and are not intended to be limiting. Many variations and modifications of the aspects disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of making foamed styrenic copolymer comprising:
reacting the styrenic copolymer with an ionomer to form a composition; and
contacting a blowing agent with the composition to form the foamed styrenic polymer wherein the ionomer is present in an amount of from about 500 ppm to about 2500 ppm and the blowing agent is present in an amount of from about 1 to about 10%.

2. The method of claim 1, wherein the reacting occurs during extrusion.

3. The method of claim 1, wherein the styrenic copolymer comprises styrene, ring-substituted styrene, disubstituted styrene, unsubstituted styrene, or a combination thereof.

4. The method of claim 1, wherein the styrenic copolymer comprises alpha-methyl styrene, p-methylstyrene, p-t-butyl styrene, or a combination thereof.

5. The method of claim 1, wherein the styrenic copolymer further comprises a comonomer.

6. The method of claim 5, wherein the comonomer comprises α-methylstyrene;
halogenated styrenes; alkylated styrenes; acrylonitrile; esters of (meth)acrylic acid with alcohols having from 1 to 8 carbons; vinylcarbazole, maleic anhydride;
divinylbenzene; butanediol diacrylate; or a combination thereof

7. The method of claim 1, wherein the styrenic copolymer further comprises an elastomer.

8. The method of claim 7, wherein the elastomer comprises a diene monomer, an aliphatic conjugated diene monomer, or a combination thereof.

9. The method of claim 7, wherein the elastomer comprises 1,3-butadiene, 2-methyl-1,3-butadiene, 2 chloro-1,3 butadiene, 2-methyl-1,3-butadiene, 2-chloro-1,3-butadiene, or a combination thereof.

10. The method of claim 7, wherein the styrenic copolymer is a high impact polystyrene.

11. The method of claim 1, wherein the styrenic copolymer is present an amount of from about 95 wt. % to about 99 wt. % based on the total weight of the composition.

12. The method of claim 1, wherein the ionomer comprises a metallic acrylate salt.

13. The method of claim 12, wherein the metallic acrylate salt comprises zinc dimethacrylate, stearyl methacrylate, hydroxyethylmethacrylate, or a combination thereof.

14. The method of claim 1, wherein the ionomer comprises zinc dimethacrylate.

15. The method of claim 1, wherein the ionomer is present in an amount of from about 500 ppm to about 2000 ppm based on the total weight of the composition.

16. The method of claim 1, wherein the composition has a melt strength ranging from about 0.035 N to about 0.048 N.

17. The method of claim 1, wherein the composition has a melt flow rate of from about 1 g/10 min to about 5 g/10 min.

18. The method of claim 1, wherein the composition has a density of from about 0.04 g/cc to about 0.1 g/cc.

19. The method of claim 1, wherein the blowing agent comprises nitrogen, carbon dioxide, water, air, pentane, hexane, dichloroethane, isobutane, or a combination thereof.

20. An article formed from a composition comprising a styrenic copolymer, an ionomer and blowing agent.

21. A foamed polystyrene comprising:
(i) a styrenic copolymer
(ii) an ionomer; and
(iii) a blowing agent wherein the ionomer is present in an amount of from about 500 ppm to about 2500 ppm; wherein the blowing agent is present in an amount of from about 1% to about 10% and wherein the foamed polystyrene has a density of from about 0.040 g/cc to about 0.100 g/cc.

22. The foamed polystyrene of claim 21, wherein the ionomer is present in an amount of from about 500 ppm to about 2500 ppm; wherein the blowing agent is present in an amount of from about 5% to about 6% and the foamed polystyrene has a density of less than about 0.100 g/cc.
